(19) United States
(12) Patent Application Publication
(10) Pub. No.: US 2026/0109220 A1
(43) Pub. Date: Apr. 23, 2026

(54) HOLOGRAPHIC INTERFERENCE PATTERN GENERATION USING IN-CHIP FIXED POINT HARDWARE ACCELERATOR

(71) Applicant: FCA US LLC, Auburn Hills, MI (US)

(72) Inventors: Esaias Pech, Auburn Hills, MI (US); Daniel Cashen, Auburn Hills, MI (US); Naved Aziz, Auburn Hills, MI (US); Rajeev Tiwari, Auburn Hills, MI (US); Emily A. Robb, Auburn Hills, MI (US)

(21) Appl. No.: 18/920,263

(22) Filed: Oct. 18, 2024

(51) Int. Cl. B60K 35/21; B60K 35/23; G03H 1/00; G06T 3/18; G06V 10/82

(52) U.S. Cl. CPC B60K 35/211; B60K 35/23; G03H 1/0005; G06T 3/18; G06V 10/82; B60K 2360/29; B60K 2360/334; B60K 2360/785

(57) ABSTRACT

A three-dimensional (3D) image projection system for a vehicle includes a memory having a trained holographic interference machine learning model stored thereon and an electronic control unit (ECU) of the vehicle comprising a central processing unit (CPU), a graphical processing unit (GPU), and a neural processing unit (NPU), wherein the NPU is configured to access, via the memory, the trained holographic interference machine learning model and, in response to a request for projection of a 3D image, utilize the trained holographic interference machine learning model to generate a holographic interference pattern image for the 3D image projection.

### FIELD

The present application generally relates to vehicle augmented/virtual reality (AR/VR) systems and, more particularly, to holographic interference pattern generation using an in-chip fixed point hardware accelerator.

### BACKGROUND

Today's vehicles are beginning to incorporate augmented/virtual reality (AR/VR) systems, such as three-dimensional (3D) windshield heads-up displays (HUDs) and 3D infotainment units. Conventional holographic image projection in vehicles is performed by a high performance computing (HPC) electronic control unit (ECU) and, more specifically, by a central processing unit (CPU) or a graphical processing unit (GPU), which substantially increases the processing load. Alternatively, this could be handled by separate field programmable gate arrays (FPGAs) or application-specific integrated circuits (ASICs), but this substantially increases vehicle costs. Accordingly, while such conventional vehicle 3D image projection systems do work well for their intended purpose, there exists an opportunity for improvement in the relevant art.

### SUMMARY

According to one example aspect of the invention, a three-dimensional (3D) image projection system for a vehicle is presented. In one exemplary implementation, the 3D image projection system comprises a memory having a trained holographic interference machine learning model stored thereon and an electronic control unit (ECU) of the vehicle comprising a central processing unit (CPU), a graphical processing unit (GPU), and a neural processing unit (NPU), wherein the NPU is configured to access, via the memory, the trained holographic interference machine learning model and, in response to a request for projection of a 3D image, utilize the trained holographic interference machine learning model to generate a holographic interference pattern image for the 3D image projection.

In some implementations, the CPU and the GPU do not utilize the trained holographic interference model. In some implementations, the CPU is configured to generate a human-machine interface (HMI) image for the 3D image projection and the GPU is configured to perform warping and rendering of the HMI image and the holographic interference pattern image, respectively. In some implementations, the CPU is configured to generate the HMI image based on a set of inputs including at least one of vehicle sensor-measured signals, inter-ECU signals, and data/signals from other connected modules or ECUs. In some implementations, the 3D image projection is for a 3D windshield heads-up display (HUD) of the vehicle.

In some implementations, the trained holographic interference machine learning model is configured to approximate the function of converting from a two-dimensional (2D) image to a phase-only hologram by feeding it an original image and the phase-only hologram. In some implementations, the trained holographic interference machine learning model is trained offline using a training dataset comprising a selected plurality of 2D images. In some implementations, the selected plurality of 2D images are obtained from a larger plurality of 2D images by applying an iterative search algorithm thereto. In some implementations, the iterative search algorithm is the Gerchberg Saxton algorithm.

According to another example aspect of the invention, a 3D image projection method for a vehicle is presented. In one exemplary implementation, the 3D image projection method comprises storing, by a memory of the vehicle, a trained holographic interference machine learning model, accessing, by an NPU of an ECU of the vehicle and via the memory, the trained holographic interference machine learning model, wherein the ECU further comprises a CPU and a GPU and, in response to a request for projection of a 3D image, utilizing, by the NPU, the trained holographic interference machine learning model to generate a holographic interference pattern image for the 3D image projection.

In some implementations, the CPU and the GPU do not utilize the trained holographic interference model. In some implementations, the 3D image projection method further comprises generating, by the CPU, a human-machine interface (HMI) image for the 3D image projection and performing, by the GPU, warping and rendering of the HMI image and the holographic interference pattern image, respectively. In some implementations, the generating of the HMI image by the CPU is based on a set of inputs including at least one of vehicle sensor-measured signals, inter-ECU signals, and data/signals from other connected modules or ECUs. the 3D image projection is for a 3D windshield HUD of the vehicle.

In some implementations, the trained holographic interference machine learning model is configured to approximate the function of converting from a 2D image to a phase-only hologram by feeding it an original image and the phase-only hologram. In some implementations, the 3D image projection method further comprises training, by another computing system, the trained holographic interference machine learning model offline using a training dataset comprising a selected plurality of 2D images. In some implementations, the selected plurality of 2D images are obtained from a larger plurality of 2D images by applying an iterative search algorithm thereto. In some implementations, the iterative search algorithm is the Gerchberg Saxton algorithm.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example 3D image projection system according to the principles of the present application;

FIGS. 2A-2B are functional block diagrams of example system architectures for the 3D image projection system according to the principles of the present application; and

FIG. 3 is a flow diagram of an example machine learning model training and 3D image projection method for a vehicle according to the principles of the present application.

### DESCRIPTION

As discussed above, today's vehicles are beginning to incorporate augmented/virtual reality (AR/VR) systems, such as three-dimensional (3D) windshield heads-up displays (HUDs) and 3D infotainment units. Conventional holographic image projection in vehicles is performed by a high performance computing (HPC) electronic control unit (ECU) and, more specifically, by a central processing unit (CPU) or a graphical processing unit (GPU), which substantially increases the processing load. Alternatively, this could be handled by separate field programmable gate arrays (FPGAs) or application-specific integrated circuits (ASICs), but this substantially increases vehicle costs. Accordingly, techniques that utilize an existing neural processing unit (NPU) of a vehicle HPC ECU or infotainment system-on-chip (SoC) to handle holographic image processing tasks.

NPUs are often underutilized as they are designed specifically for executing machine learning models (e.g., neural networks). The proposed techniques develop and train a machine learning model to approximate the function of converting from a two-dimensional (2D) image to a phase-only hologram. In one embodiment, this includes generating a training dataset using an iterative algorithm (e.g., Gerchberg Saxton) and applying direct binary search and random dithering thereto to produce ideal and diverse target images leveraging a fast Fourier transform (FFT) evaluation method. The trained machine learning model can then be quantized to run on the NPU with low latency and low power. Potential benefits include reduced costs and improved developer productivity and quality control.

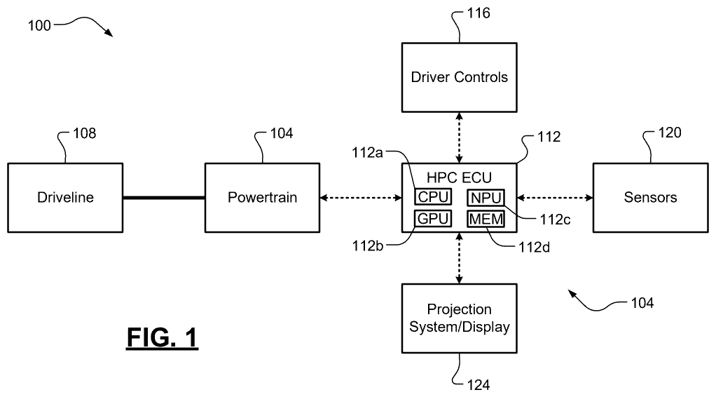

Referring now to FIG. 1, a functional block diagram of a vehicle 100 having an example 3D projection system 104 according to the principles of the present application is illustrated. The vehicle 100 comprises a powertrain 108 (an engine, an electric motor, or some combination thereof) that is configured to generate and transfer drive torque to a driveline 112 (a differential, axles or half shafts, etc.) for vehicle propulsion. The vehicle 100 also includes one or more SoCs or HPC ECUs 112 that each include a CPU 112a, a GPU 112b, an NPU 112c, and a memory (MEM) 112d.

One example task performed by the one or more HPC ECUs 112 is controlling the powertrain 108 to satisfy a driver torque request received via driver controls 116 (e.g., an accelerator pedal). The HPC ECU 112 is also configured to obtain various measurements or signals (speeds, temperatures, etc.) from a plurality of vehicle sensors 120. For purpose of the present application, the vehicle 100 further includes a projection system or display 124 configured to holographic or 3D image projection.

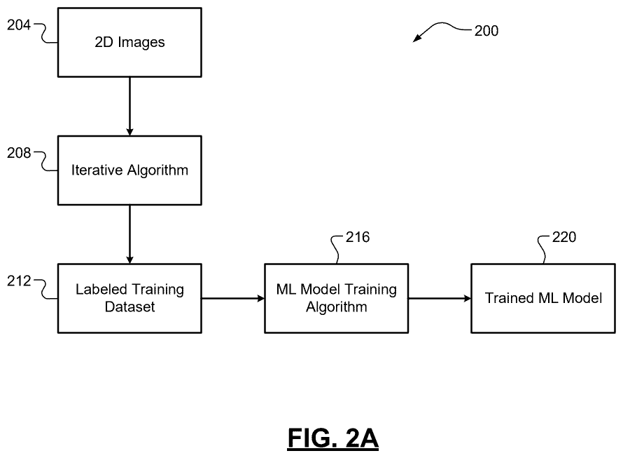

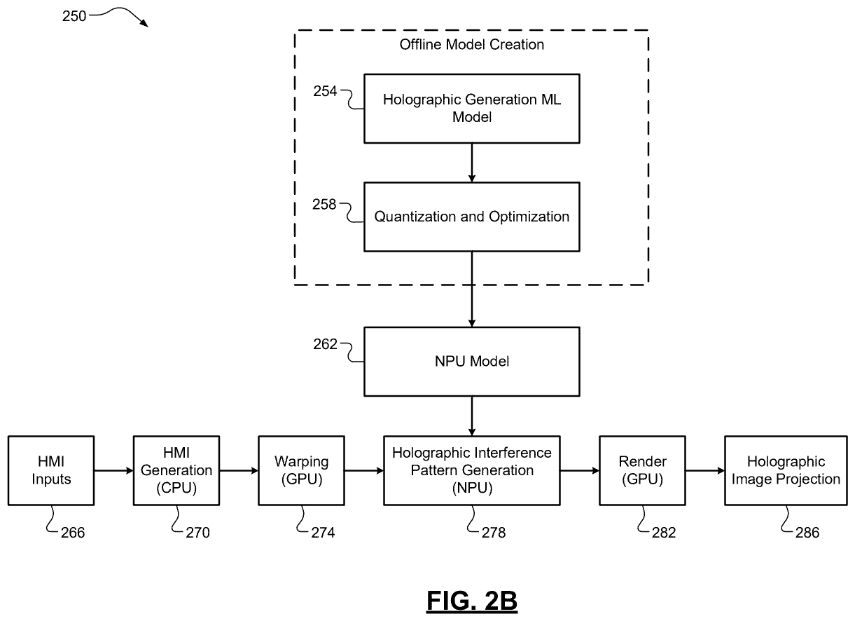

Referring now to FIGS. 2A-2B and with continued reference to FIG. 1, functional block diagrams of example system architectures 200, 250 for the 3D image projection system 104 according to the principles of the present application are illustrated. The proposed techniques use an in-chip hardware accelerator (e.g., the NPU 112c) to compute a hologram prior to being rendered on the projection or display system 124. Test data comprising a plurality of 2D images 204 is initially gathered or collected. The 2D images 204 could be any suitable type of image, such as red/green/blue (RGB) images or luma/chroma plane (YUV) images. The next step in creating a ML model is having a training dataset. To generate a training dataset, a traditional iterative algorithm 208 could be used (e.g., the Gerchberg Saxton, or GS algorithm).

For example, direct binary search and random dithering can be applied at scale in the GS algorithm 208 results to produce a labeled training dataset 212 comprising ideal and diverse target images leveraging an FFT evaluation method. Target images must present both the most accurate representation but also the total range of possible solutions. A machine learning (ML) model training algorithm 216 is then applied to the labeled training dataset to generate a trained ML model 220. For example, the trained ML model 220 could be a neural network type model having a desired number of layers/nodes.

In application, the trained ML model 220 is configured to approximate the function of converting from a 2D image (RGB, YUV, etc.) to a phase-only hologram by feeding it the original image and the phase-only hologram. In FIG. 2B, the offline model creation process is shown to include creating the holographic generation ML model 254 and then quantization and optimization 258 such that it is capable of running on a fixed-point NPU accelerator. The quantized ML model (also NPU model) 262 can be executed by an NPU (e.g., NPU 112c) with low latency and low power.

The bottom portion of FIG. 2B illustrates the dataflow. HMI inputs 266, which can include vehicle signals (speed, heading/direction, temperature, etc.), such as from sensors 120, inter-ECU signals, and/or data/signals from other connected modules/ECUs, are collected and then AR and/or human-machine interface (AR/HMI) is generated by the CPU 112a at 270. Next, the GPU 112b performs warping of the AR/HMI image. At inference, the ML model 262 takes an input image (after warping 274) and then outputs a phase-only hologram 278 in the form of an image that can be clocked out to the projection or display system 124 at 286. This also includes the GPU 112b performing rendering at 282. Integrating the hardware components directly into an SoC allows for efficient computing while generating effective holographic interference patterns. This approach also avoids usage of an external FPGA or ASIC by leveraging the existing computing power of an HPC ECU. Further benefits include reduced power consumption, reduced latency (especially for latency sensitive solutions such as AR/VR), and reduced system cost (making it suitable for a wide range of applications such as holographic displays, microscopy, scientific visualization, etc.). This also helps with low latency applications and scalability.

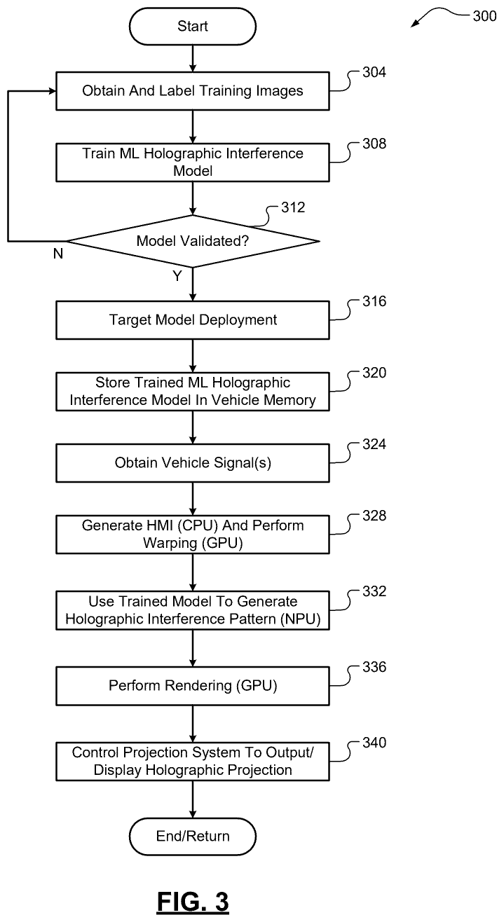

Referring now to FIG. 3 and with continued reference to the previous figures, a flow diagram of an example machine learning model training and 3D image projection method 300 for a vehicle according to the principles of the present application is illustrated. Initial steps 304-312 are for the ML model creation or generation and training. At 304, a training dataset comprising a plurality of 2D images (RGB, YUV, etc.) are obtained and labeled using a suitable iterative searching algorithm (e.g., the GS algorithm). At 308, the ML model is trained using the training dataset and a suitable ML training algorithm. At 312, the trained ML model is evaluated to determine that it has sufficient accuracy and can be validated. When false (i.e., when more training is required), the method 300 could end or return to 304 or 308.

When true (i.e., when the trained ML model is validated), the method 300 proceeds to 316. At 316, the target model is deployed (e.g., quantization and optimization for the particular embedded processor, similar to 258 in FIG. 2B). At 320, the trained ML holographic interference model is stored in a memory of a vehicle (e.g., memory 112d of vehicle 100). At 324, the vehicle signal(s) for display are collected or obtained. At 328, the CPU 112a generates the HMI image and the GPU 112b then performs warping (e.g., to skew the HMI image for display on a curved surface such as a windshield of the vehicle 100. At 332, the NPU 112c uses the trained ML model to generate a holographic interference pattern in the form of an image. At 336, the GPU 112b performs rendering for the final display. Finally, at 340, the rendered 3D or holographic image is displayed to the user (e.g., a driver of the vehicle 100) by controlling the projection/display system 124. The method 300 then ends or returns to 320 for one or more additional display generation cycles.

To summarize, in infotainment HPCs, the GPU is used to render displays while the NPU is allocated to computer vision and ML algorithms. Using the NPU for graphics tasks allows the GPU's resources to be freed up for other purposes. Cost efficiency is achieved by leveraging the NPU in the SoC for graphics purposes and this allows to more software to be fit in a smaller SoC. Developers productivity is improved as holographic visualization enables engineers and designers to visualize and iterate on product designs in three dimensions, reducing development time and costs. Quality control and inspection is also improved as holographic imaging can be used for non-destructive testing and inspection of manufactured components, identifying defects, and ensuring quality standards are met. Further, this opens up the AR/VR space by integrating holographic interference patterns to enhance the immersive experience by providing realistic 3D visualizations. This opens opportunities in gaming, entertainment, education, training, and simulation, driving user engagement and monetization.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A three-dimensional (3D) image projection system for a vehicle, the 3D image projection system comprising:
a memory having a trained holographic interference machine learning model stored thereon; and
an electronic control unit (ECU) of the vehicle comprising a central processing unit (CPU), a graphical processing unit (GPU), and a neural processing unit (NPU), wherein the NPU is configured to:
access, via the memory, the trained holographic interference machine learning model; and
in response to a request for projection of a 3D image, utilize the trained holographic interference machine learning model to generate a holographic interference pattern image for the 3D image projection.

2. The 3D image projection system of claim 1, wherein the CPU and the GPU do not utilize the trained holographic interference model.

3. The 3D image projection system of claim 2, wherein the CPU is configured to generate a human-machine interface (HMI) image for the 3D image projection and the GPU is configured to perform warping and rendering of the HMI image and the holographic interference pattern image, respectively.

4. The 3D image projection system of claim 3, wherein the CPU is configured to generate the HMI image based on a set of inputs including at least one of vehicle sensor-measured signals, inter-ECU signals, and data/signals from other connected modules or ECUs.

5. The 3D image projection system of claim 4, wherein the 3D image projection is for a 3D windshield heads-up display (HUD) of the vehicle.

6. The 3D image projection system of claim 1, wherein the trained holographic interference machine learning model is configured to approximate the function of converting from a two-dimensional (2D) image to a phase-only hologram by feeding it an original image and the phase-only hologram.

7. The 3D image projection system of claim 6, wherein the trained holographic interference machine learning model is trained offline using a training dataset comprising a selected plurality of 2D images.

8. The 3D image projection system of claim 7, wherein the selected plurality of 2D images are obtained from a larger plurality of 2D images by applying an iterative search algorithm thereto.

9. The 3D image projection system of claim 8, wherein the iterative search algorithm is the Gerchberg Saxton algorithm.

10. A three-dimensional (3D) image projection method for a vehicle, the 3D image projection method comprising:
storing, by a memory of the vehicle, a trained holographic interference machine learning model;
accessing, by a neural processing unit (NPU) of an electronic control unit (ECU) of the vehicle and via the memory, the trained holographic interference machine learning model, wherein the ECU further comprises a central processing unit (CPU) and a graphical processing unit (GPU); and
in response to a request for projection of a 3D image, utilizing, by the NPU, the trained holographic interference machine learning model to generate a holographic interference pattern image for the 3D image projection.

11. The 3D image projection method of claim 10, wherein the CPU and the GPU do not utilize the trained holographic interference model.

12. The 3D image projection method of claim 11, further comprising generating, by the CPU, a human-machine interface (HMI) image for the 3D image projection and performing, by the GPU, warping and rendering of the HMI image and the holographic interference pattern image, respectively.

13. The 3D image projection method of claim 12, wherein the generating of the HMI image by the CPU is based on a set of inputs including at least one of vehicle sensor-measured signals, inter-ECU signals, and data/signals from other connected modules or ECUs.

14. The 3D image projection method of claim 13, wherein the 3D image projection is for a 3D windshield heads-up display (HUD) of the vehicle.

15. The 3D image projection method of claim 10, wherein the trained holographic interference machine learning model is configured to approximate the function of converting from a two-dimensional (2D) image to a phase-only hologram by feeding it an original image and the phase-only hologram.

16. The 3D image projection method of claim 15, further comprising training, by another computing system, the trained holographic interference machine learning model offline using a training dataset comprising a selected plurality of 2D images.

17. The 3D image projection method of claim 16, wherein the selected plurality of 2D images are obtained from a larger plurality of 2D images by applying an iterative search algorithm thereto.

18. The 3D image projection method of claim 17, wherein the iterative search algorithm is the Gerchberg Saxton algorithm.
